(19) United States
(12) Patent Application Publication
(10) Pub. No.: US 2014/0258121 A1
(43) Pub. Date: Sep. 11, 2014

(54) METHOD AND APPARATUS FOR PROVIDING SECURED ANONYMIZED PAYMENT

(71) Applicant: Madhusudan Raman, Sherborn, MA (US)

(72) Inventor: Madhusudan Raman, Sherborn, MA (US)

(73) Assignee: Verizon Patent and Licensing Inc., Basking Ridge, NJ (US)

(21) Appl. No.: 13/793,838

(22) Filed: Mar. 11, 2013

(51) Int. Cl. G06Q 20/38

(52) U.S. Cl. CPC G06Q 20/383
USPC 705/44

(57) ABSTRACT

An approach for secured payment through anonymized settlement services without the use of physical trusted service management (TSM) devices includes receiving a payment request from a first user directed to a second user, wherein the payment request includes, at least in part, an abstracted identity of the first user, determining one or more payment accounts associated with the first user based, at least in part, on the abstracted identity, initiating a payment using the one or more payments accounts to the second user based on the payment request, and sending an acknowledgement message of the payment to the second user, wherein the acknowledgement message includes anonymized information associated with the payment.

### BACKGROUND INFORMATION

The growth of mobile device transactions has led to convenience and security concerns over their use. Use of card emulation technologies gives users the ability to pay others with only a mobile device. This ease of use comes at a price of challenging security issues that have been addressed through the use of intermediary trusted service managers (TSMs). Unfortunately, these TSMs currently process transactions through physical devices attached to mobile devices. As a result, TSM device installation limits which mobile devices might be able to use Near Field Communications (NFCs), Bluetooth, WiFi, Holographic Laser Projection with Infrared or Ultrasound return, and/or Near Sound Data Transfer as payment transfer and transport methods, and many potential users are lost.

Based on the foregoing, there is a need for an approach to securely transmit payments from mobile devices without a physical TSM device.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of securely transmitting payments without a physical TSM device, according to one embodiment;

FIG. 2 is a diagram of a system utilizing an anonymous settlement services platform over a cloud network, according to one embodiment;

FIG. 3 is a diagram of an anonymous settlement services platform, according to one embodiment;

FIG. 4 is a flowchart of a process for a secured payment in conjunction with the anonymous settlement services platform, according to one embodiment;

FIG. 5 is a flowchart of a process for an anonymous settlement services platform to generate a payment from a first user to second user, according to one certain embodiment;

FIG. 6 is a flowchart of a process for a first user mobile device to make a payment to a second user, according to one certain embodiment;

FIG. 7 is a diagram of a computer system that can be used to implement various exemplary embodiments; and

FIG. 8 is a diagram of a chip set that can be used to implement various exemplary embodiments.

### DESCRIPTION OF THE PREFERRED EMBODIMENT

An apparatus, method, and software for securely transmitting payments from mobile devices are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

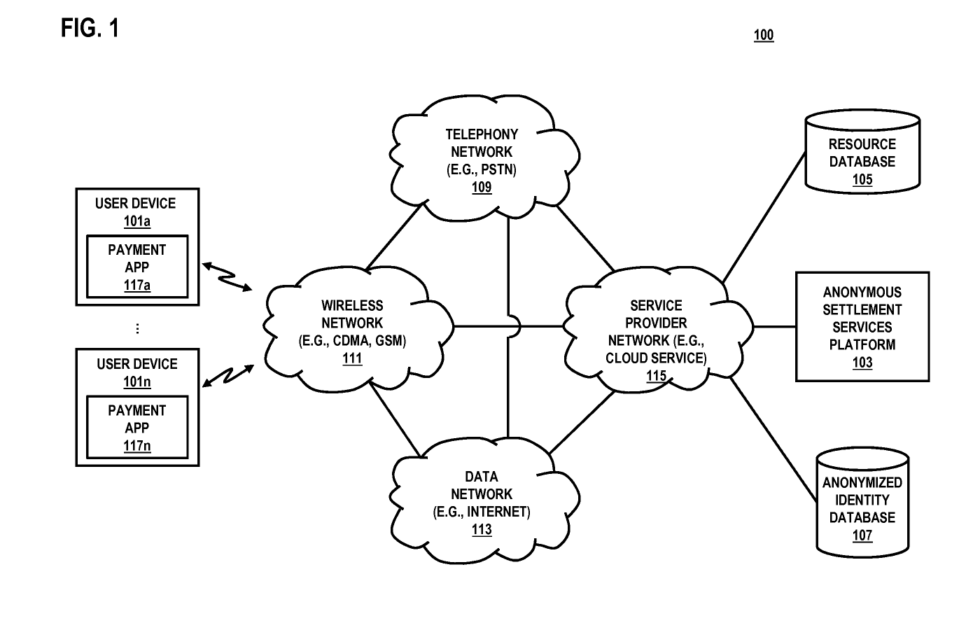

FIG. 1 is a diagram of a system to securely transmit payments from mobile devices without a physical TSM device by utilizing an anonymous settlement services platform 103, according to one embodiment. For the purpose of illustration, the system 100 may include one or more user devices 101a-101n with payment applications 117a-117n that may be utilized to access anonymous settlement services provided by the anonymous settlement services platform 103 over one or more networks, including a telephony network 109, a wireless network 111, a data network 113, a service provider data network 115, etc. The anonymous settlement service may be presented as a marketplace or “payment place” in which the users (subscribers) are presented with a forum to view resources and managed services for payment. In one embodiment, the user devices 101a-101n may be able to use Near Field Communications (NFCs), Bluetooth, WiFi, Holographic Laser Projection with Infrared or Ultrasound return, Near Sound Data Transfer, etc. to initiate a payment in any manner such as placement near an object, swipe, tap, etc. In one embodiment, the service can make payments through combinations of many payment resources, including credit, debit, loyalty points, tender, virtual currencies, and other currencies. It is noted that such applications can also be eliminated and the functions of the applications can instead be implemented via a browser accessing a website, which can be part of the anonymous settlement services platform 103. According to one embodiment, these services may be included as part of managed services supplied by a service provider (e.g., a wireless communication company) as a hosted or a subscription-based service made available to users of the user devices 101 through the service provider data network 115, which, in one embodiment, may be a cloud network service. As such, the anonymous settlement services platform 103 may, for instance, be configured to aid in a secure transaction between users. In this regard, the anonymous settlement services platform 103 may provide more secure and efficient transactions between parties.

As used herein, a user refers to a person, mobile device, shopping basket, vending machine, merchant or other possible payees and payors. The terms retailer and merchant are used interchangeably to refer to an entity that offers goods and/or services. The term channel partner refers to a business entity serving payees and payors for payment transactions and managing services and/or resources provided for payment.

As shown, the anonymous settlement services platform 103 may be part of or connected to the service provider network 115. In certain embodiments, the anonymous settlement services platform 103 may include (or have access to through the service provider network 115) a resource database 105 and an anonymized identity database 107. The anonymized identity database 107, in some embodiments, stores data needed to validate the abstracted identity of a user and user resources as needed through use of an anonymized uniform resource identifier. In one embodiment, the anonymized identity database 107 may store the anonymized uniform resource identifier.

The resource database 105 may, for instance, be utilized to access or store user information, such as user identifiers, passwords, device information associated with users, payment resource information associated with users, such as credit cards, debit cards, banks, loyalty points, virtual currencies (e.g., bitcoins), gold, silver, etc. These payment resources will have associated identifiers, merchants associated with such cards, etc. While specific reference will be made thereto, it is contemplated that the system 100 may embody many forms and include multiple and/or alternative components and facilities. In addition, although various embodiments are described with respect to loyalty points and credit cards in mind, it is contemplated that the approach described herein may be used with other payment methods. In addition, although various embodiments of card emulation are described by use of NFC, it is contemplated that the approach described herein may be used with other cashless readers, rugged tap, swipe readers, basket shopping, vending machines, etc. In addition, although various embodiments are described with respect to non-physical device TSMs in mind it is contemplated that the approach described herein may be used with other types of similar non-physical device trusted service managers.

It is recognized that, in payment through card emulation methods on mobile devices, preserving security can be a challenge in that third parties have the ability to interfere with similar payments. That is, a third party may create a security risk for the payment by receiving payment information. As such, a TSM is used for securing payment. For example, to purchase a drink from a local store, user A opens an application on their mobile phone. After authenticating the purchase, user A receives verification from the TSM. Without verification from the TSM, a purchase may not proceed. After, the verification, payment from user A proceeds through the TSM to anonymize the payment. Additionally, throughout the communication process between the payment accounts and the payment service, a security threat may occur. The TSM will then initiate notification to the user and block any security threats.

To address the above issue of payment security without a physical TSM device, the system 100 of FIG. 1 provides the capability to facilitate, in a safe and secure manner, a secure anonymized payment. In one use case, the system 100 may also provide for payment through use of included credit card payment accounts. By way of example, a user can launch, via user device 101a, payment application 117a to request payment to a merchant of a product by taking a picture of the bar code or the product itself. Under this scenario, the payment application 117a communicates with the anonymous settlement services platform 103 to provide for secure payment by verifying the user with the anonymized identity database 107. The user might also specify a specific credit card resource to use within the payment application 117a with the anonymized uniform resource identifier. The anonymized uniform resource identifier further secures the payment from threats by needing the anonymized uniform resource identifier to access the payment resources directly. The separation of the user from the payment accounts further secures against any threats against communications between the user and payment accounts. In this example, the user device 101a is a mobile device (e.g., smartphone, netbook, laptop, etc.) that may also be configured to utilize a browser to communicate with the anonymous settlement services platform 103. Among other functions, the anonymous settlement services platform 103 will determine the product from the picture (or other one-dimensional, two-dimensional, or three-dimensional optical media recognition codes) to find the unit price and adjust the stock number with the retailer. The anonymous settlement services platform 103 also determines the user's possible payment accounts based on the resource database 105 in combination with the payment request. In one embodiment, the payment request may include a payment location which may determine the payment account. For example, if the payment occurs at a retailer and the user's payment resources include a payment account that includes the retailer's associated credit card, then that credit card would be used for payment. If the credit card uses a point system upon purchase, points would be credited to the user's payment account through notice by the anonymous settlement services platform 103 or use upon payment. Thereafter, the payment is sent to the retailer and an acknowledgement message is sent to the retailer. In other embodiments, the payment accounts may be determined, anonymized and generated for the user to select from to finish payment.

At this point, the payment is complete. If a security threat had occurred or the anonymous settlement services platform 103 had not verified the user's abstracted identity, then no payment would have been made and a message would have been generated stating the issue.

In one use case, the payment account is a loyalty points account that may include coupons for points, or payment currency for points. For example, a user purchases a good at a retailer and wants to use points to pay for the good and apply a coupon related to the loyalty points account. The anonymous settlement services platform 103 determines the price of the good (e.g., $200), and applies the loyalty points account. The anonymous settlement services platform 103 accesses the loyalty points account to find the coupon (e.g., 25% off purchase) to get an intermediate price (e.g., $150). The anonymous settlement services platform 103 accesses the loyalty points account and applies the points necessary toward the cost of the good. Prior to the application of the points, the anonymous settlement services platform 103 will translate the points (e.g., user has 10,000 points) into the payment currency (e.g., U.S. Dollars) necessary for payment of the retailer (e.g., 10 points/dollar; thus 1,500 points are needed leaving user with 8,500 points). In one embodiment, if there are not enough points to apply toward the cost of the good (e.g., user only has 1,000 points), then the anonymous settlement services platform 103 may query the user for whether they want to continue to apply the points and pay the remaining balance with another payment method (e.g., credit card payment account) or just pay the full balance with another payment method. In other embodiments, this selection may be determined by the anonymous settlement services platform 103 or payment may be cancelled without querying the user.

In one embodiment, the payment account is a credit card account that may have a limit. For example, a user purchases a good from a vending machine. The anonymous settlement services platform 103 determines the price of the good is $3 from the product selection of the vending machine and applies the credit card account. The credit card account, which already has a $199 balance, is then checked against its limit of $200. The anonymous settlement services platform 103 will then notify the user and the vending machine company that the payment did not go through because of insufficient funds/remaining balance. If the credit card account instead had a balance of $194, the payment would go through and the anonymous settlement services platform 103 would notify the vending machine of the payment to release the product.

For illustrative purposes, the networks 109-115 may be any suitable wireline and/or wireless network, and be managed by one or more service providers. For example, telephony network 109 may include a circuit-switched network, such as the public switched telephone network (PSTN), an integrated services digital network (ISDN), a private branch exchange (PBX), or other like network. Wireless network 111 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 113 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 109-115 may be completely or partially contained within one another, or may embody one or more of the aforementioned infrastructures. For instance, the service provider network 119 may embody circuit-switched and/or packet-switched networks that include facilities to provide for transport of circuit-switched and/or packet-based communications. It is further contemplated that networks 109-115 may include components and facilities to provide for signaling and/or bearer communications between the various components or facilities of system 100. In this manner, networks 109-115 may embody or include portions of a signaling system 7 (SS7) network, or other suitable infrastructure to support control and signaling functions.

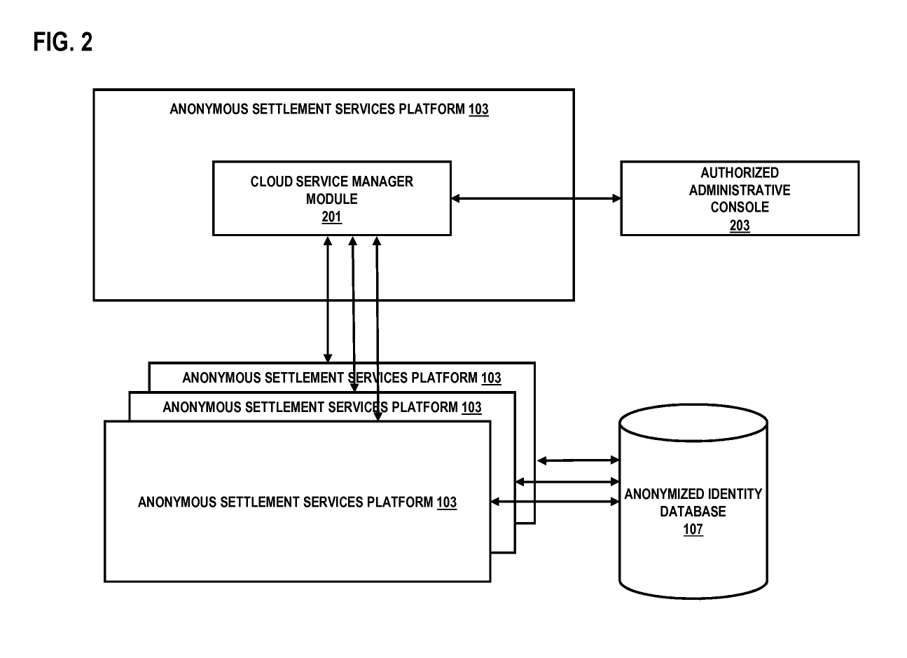

FIG. 2 is a diagram of an anonymous settlement services platform 103 utilized over a cloud network, according to one embodiment. By way of example, the anonymous settlement services platform 103 is controlled by a cloud service manager module 201. The authorized administrative console 203 is used to access the cloud service manager module 201 to use the cloud service manager module 201 to create instances of the anonymous settlement services platform 103 for a channel partner.

The cloud service manager module 201 generates an instance of the anonymous settlement services platform 103 on demand associated with a channel partner. Each instance of the anonymous settlement services platform 103 gives the channel partner requesting access through the cloud network the ability to manage the services provided. These services include management of anonymized identities of associated payment accounts, optical media recognition types associated with payments, raw media types associated with payments, stock keeping unit types associated with payments, currency conversions to ISO 4217 currencies, currency persistence via crypto-currencies, Man-in-the-Middle resolution associated with alert generation and dispatch, etc.

The channel partner may use the anonymous uniform resource identifier to tokenize individual payment accounts and edit, add to or remove from the anonymized identity database 107. The anonymous uniform resource identifier sets a compact string of characters used to identify payment accounts of each user. This creates the ability to have a secure anonymized payment by limiting exposure of actual payment account information and user information to the public.

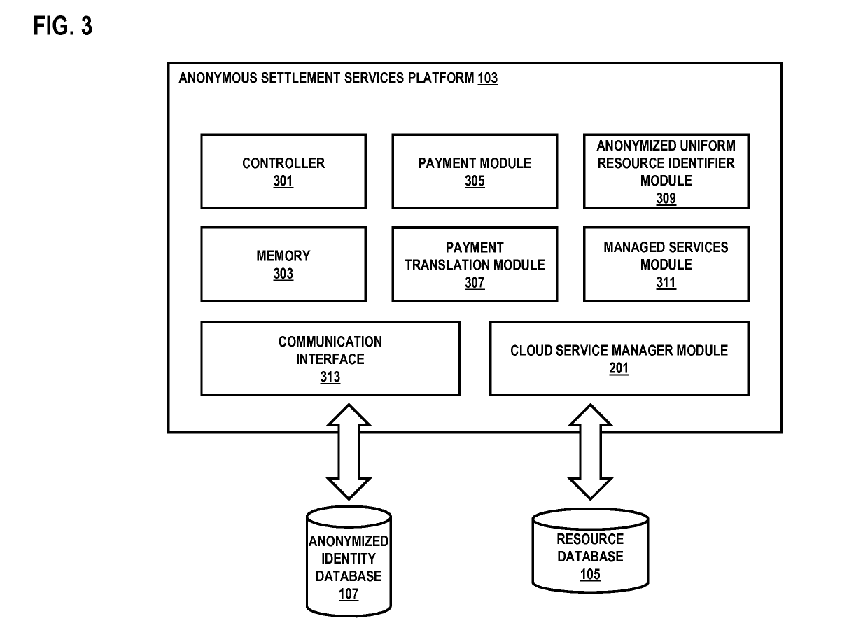

FIG. 3 is a diagram of an anonymous settlement services platform 103 utilized over the system 100. By way of example, the anonymous settlement services platform 103 includes one or more components for providing secured anonymized payments. It is contemplated that the functions of these components may be combined in one or more components or performed by other components of equivalent functionality. In this embodiment, the anonymous settlement services platform 103 includes a controller 301, a memory 303, a payment module 305, a payment translation module 307, an anonymized uniform resource identifier module 309, a managed services module 311, a communication interface 313, and cloud service manager module 201.

The controller 301 may execute at least one algorithm (e.g., stored at the memory 303) for executing functions of the anonymous settlement services platform 103. For example, the controller 301 may interact with the payment module 305 to secure exchange of a payment to a second user. The payment module 305 may work with the other modules to obtain and analyze such information in order to determine the exchange.

In certain embodiments, the payment module 305 may work with the payment translation module 307 to determine whether a payment account may require translation (e.g., loyalty points account) and translate the payment account to a payment currency (e.g., U.S. Dollars). The payment translation module 307 may also aid the payment module 305 in determining payment accounts, as determined through the resource database 105, to use for payment by translating payment accounts prior to determination in order to find the payment account for the payment. For example, the payment translation module 307 can aid in determining to not use a translated loyalty points account with a deficient points balance and instead use a credit card payment account meeting the needs of the purchase in full.

In certain embodiments, the payment module 305 may work with the anonymized uniform resource identifier module 309 to analyze the payment accounts of an abstracted identity of a user as confirmed with the anonymized identity database 107 through the communication interface 313. The anonymized uniform resource identifier module 309 may also edit, add or remove payment accounts and identify resources through anonymized strings of characters used in identifying. Payment information on a payment account may then be stored under the payment account information which might be verified by merchants upon a later step (e.g., points application to an account after purchase).

In certain embodiments, the payment module 305 may operate with the managed services module 311 to determine products or services that are being purchased, purchase prices, stock numbers, product identification numbers, etc. The managed services module 311 may then also communicate with the merchant to verify products or services being purchased and update product or service information as needed.

In certain embodiments, the payment module 305 may operate with the cloud service manager module 201 to manage the anonymous settlement services platform 103. The cloud service manager module 201 generates an instance on demand associated with a channel partner through communication interface 313 managing the services provided. This creates the ability for remote management of the anonymous settlement services platform 103 by further limiting exposure of information exposed to the public by unsecured communications.

In certain embodiments, the payment module 305 may determine which payment account to use to complete a payment request. As an example, 20 products are purchased for $600 at a retailer by a user and each of the user's multiple credit card payment accounts is close to its limit (e.g., credit card A has $300 left, credit card B has $500 left, and credit card C has $150 left). The payment module 305 may determine which payment account to use by the one furthest from its limit (e.g., credit card B), and then continue to use the next furthest to pay the remaining balance, if necessary (e.g., use credit card A to pay the remaining $100).

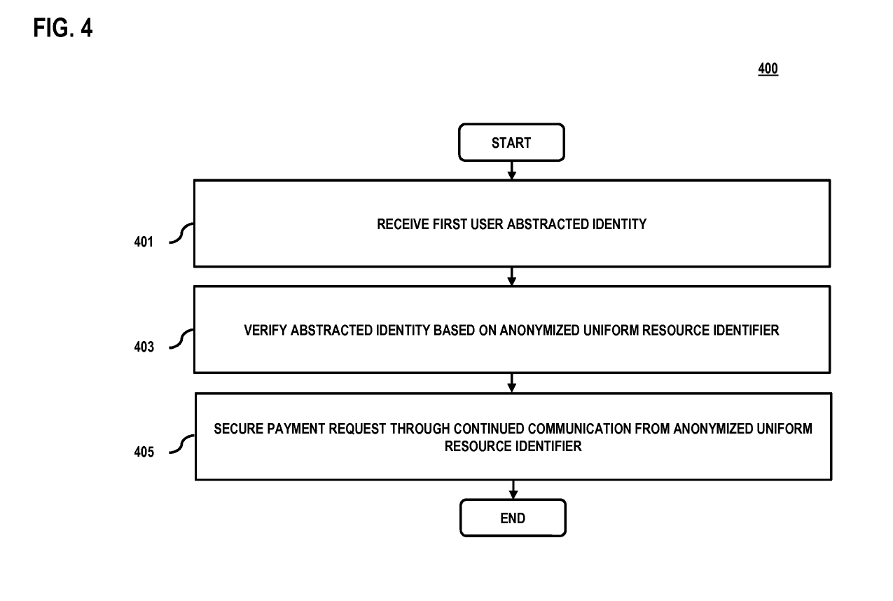

FIG. 4 is a flowchart of a process for a secured payment through an anonymized uniform resource identifier, according to one embodiment. For the purpose of illustration, process 400 is described with respect to FIG. 1. It is noted that the steps of the process 400 may be performed in any suitable order, as well as combined or separated in any suitable manner. As shown in FIG. 4, in step 401, the anonymous settlement services platform 103 may receive a first user abstracted identity. This request may originate from the user of user device 101a via payment application 117a or a web browser. The first user abstracted identity may include a number, expiration date, etc. The request may also originate with respect to receiving a payment request from the user of the user directed to a second user.

In step 403, the anonymous settlement services platform 103 may verify the first user abstracted identity based on an anonymized uniform resource identifier. The first user abstracted identity may be compared against information in the anonymized identity database 107 by the anonymous settlement services platform 103. This initiates the payment by notifying the user device 101a of confirmation of identity.

In step 405, the anonymous settlement services platform 103 secures the payment request through continued communication using the anonymized uniform resource identifier. In certain embodiments, the payment request is then sent to a PCI compliant Payment Gateway to process the payment request. This separation of resources and users safely buffers the users from security threats created by direct access to payment accounts.

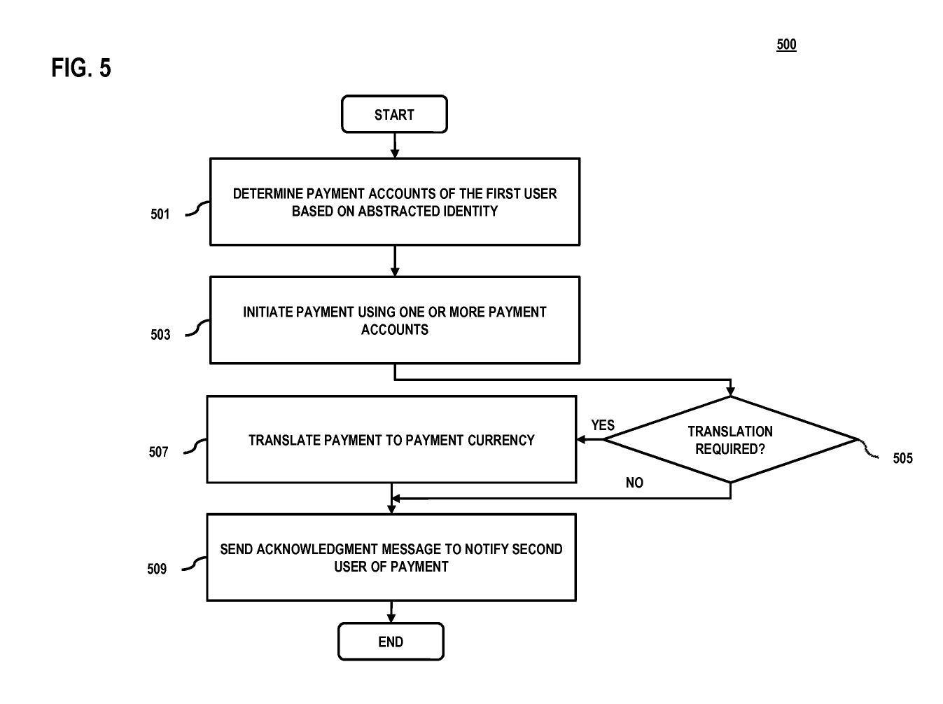

FIG. 5 is a flowchart of a process for the anonymous settlement services platform 103 to generate a payment from a first user to a second user, according to one embodiment. For the purpose of illustration, process 500 is described with respect to FIG. 1. It is noted that the steps of the process 500 may be performed in any suitable order, as well as combined or separated in any suitable manner.

In step 501, upon receiving a payment request, the anonymous settlement services platform 103 determines payment accounts of the first user associated with the payment request based on an abstracted identity. The anonymized uniform resource identifier uses the abstracted identity to determine associated payment accounts as applied to the resource database 105. The payment accounts might include, for example, credit cards, debit cards, bank accounts, loyalty point accounts, virtual currencies (e.g., bitcoins), gold, silver, trading accounts, foreign currencies, etc. As a result, payment account currency translation may be necessary. In one embodiment, the payment accounts used are determined by the user (e.g., the user is queried for a choice from the available payment accounts, or user remembers and includes the payment account in the generation of their payment request). In another embodiment, the payment accounts used are determined based on the payment location (e.g., the user payment request is generated at a specified retailer and use of the credit card and/or loyalty point accounts would be selected for payment). In another embodiment, the payment accounts used are determined based on the currency type allowed as payment by the second user. In another embodiment, the payment accounts used are determined based on user abstracted identity (e.g. a user has multiple identities and has specific accounts associated to each identity).

In step 503, the anonymous settlement services platform 103 initiates payment using one or more of the above determined payment accounts. For example, the payment account in its anonymized form is identified by the anonymized uniform resource identifier to then begin the process of payment with the payment account. The anonymous settlement services platform 103 then communicates through a PCI compliant Payment Gateway, if necessary, to access resources and/or receive pertinent account information (e.g., types of funds, insufficient funds, limited balance, etc.).

In step 505, the anonymous settlement services platform 103 determines whether the payment account used requires translation to a payment currency required by the second user. For example, the second user may specify a single currency or multiple types of currency allowed for payment (e.g., second user allows payment through bitcoins and the Euro). If translation is required, the process 500 proceeds to step 507. If translation is not required, the process 500 proceeds to step 509.

In step 507, the anonymous settlement services platform 103 translates payment to the correct payment currency. For example, the anonymous settlement services platform 103 translates the user's loyalty points payment to U.S. Dollars at a prescribed rate. This translation information may be determined by channel partners through managed services, current market valuations tied to certain indices, etc.

In step 509, the anonymous settlement services platform 103 sends an acknowledgement message to notify the second user of payment. For example, when the payment is sent to the second user's account, the second user may have no idea payment has been received. Thus, the anonymous settlement services platform 103 generates and sends an acknowledgement to the second user. In other embodiments, the anonymous settlement services platform 103 generates and sends an acknowledgement to both the first user and second user, or to just the first user.

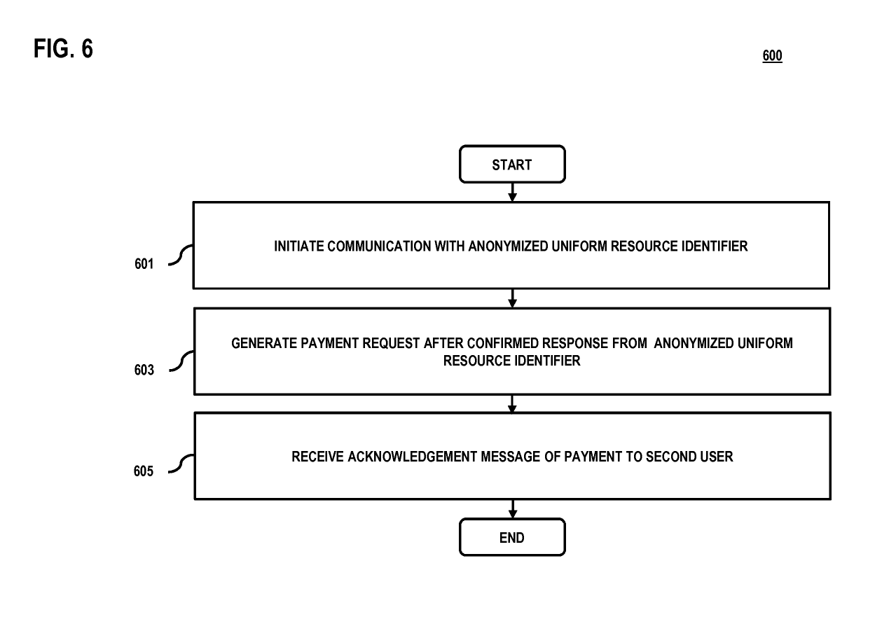

FIG. 6 is a flowchart of a process for a first user mobile device to make a payment to a second user, according to certain embodiments. Continuing with the example of FIG. 1, user device 101a can execute process 600 associated with executing a payment application 117a. In the alternative, the process 600 may be implemented via a browser accessing a website. In step 601, the payment application 117a initiates communication with the anonymous settlement services platform 103. The communication begins with the anonymized uniform resource identifier in order to minimize security risks. The anonymous payment is then authenticated and secured from Man-in-the-Middle threats and other security risks by anonymizing and buffering the user information and payment account information.

In step 603, the payment application 117a generates a payment request after receiving a confirmed response from anonymous settlement services platform 103. The payment request is now secured through use of the anonymized uniform resource identifier and the payment application 117a generates a payment request. In one embodiment the payment request may include a product or service (e.g., determined by processing optical media recognition types (e.g. picture of a product), a raw media type, a stock keeping unit type (e.g., bar code, QR code), a currency conversion, a currency persistence or combination thereof), payment location, abstracted identity of user, time, date, price of product or service, payment accounts to be used, payment account determination logic, etc.

In step 605, after generation of the payment request and payment to the second user, as discussed above, the payment application 117a receives acknowledgement message of payment to second user. This verifies the payment has gone through and no further action by the first user is necessary.

The systems and processes of FIGS. 1-6, in certain embodiments, advantageously provide for secure payments using mobile devices without a physical TSM device associated with mobile devices. Thus, all user mobile devices may be used in payment for goods or services. The systems and processes of FIGS. 1-6 also accommodate different payment accounts and the ability to apply one or more account types to the payment of services and products.

The processes described herein for securely transmitting payments from mobile devices without a physical TSM can be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

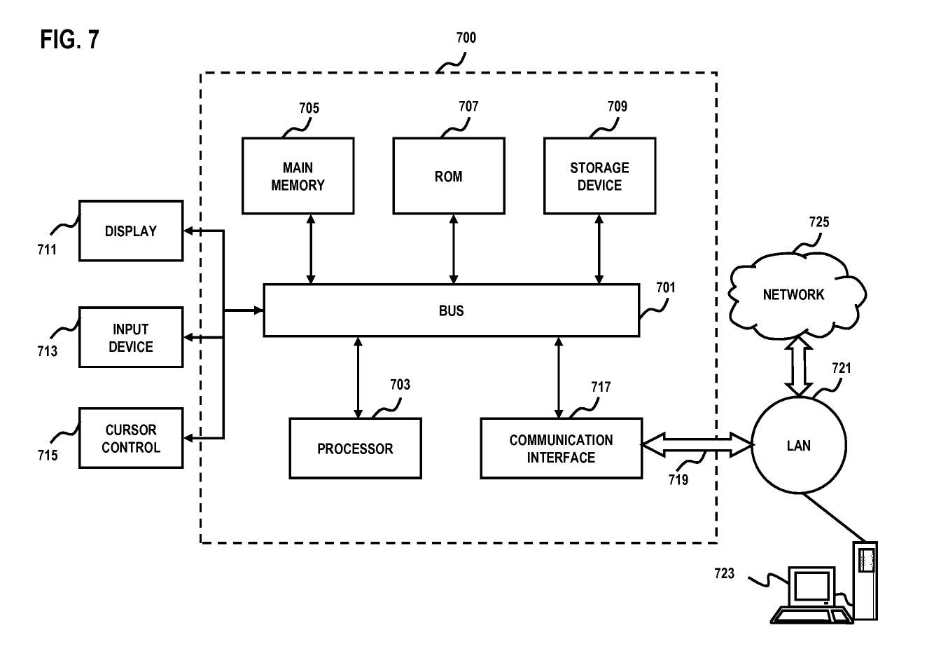

FIG. 7 illustrates computing hardware (e.g., computer system) upon which an embodiment according to the invention can be implemented. The computer system 700 includes a bus 701 or other communication mechanism for communicating information and a processor 703 coupled to the bus 701 for processing information. The computer system 700 also includes main memory 705, such as random access memory (RAM) or other dynamic storage device, coupled to the bus 701 for storing information and instructions to be executed by the processor 703. Main memory 705 also can be used for storing temporary variables or other intermediate information during execution of instructions by the processor 703. The computer system 700 may further include a read only memory (ROM) 707 or other static storage device coupled to the bus 701 for storing static information and instructions for the processor 703. A storage device 709, such as a magnetic disk or optical disk, is coupled to the bus 701 for persistently storing information and instructions.

The computer system 700 may be coupled via the bus 701 to a display 711, such as a cathode ray tube (CRT), liquid crystal display, active matrix display, or plasma display, for displaying information to a computer user. An input device 713, such as a keyboard including alphanumeric and other keys, is coupled to the bus 701 for communicating information and command selections to the processor 703. Another type of user input device is a cursor control 715, such as a mouse, a trackball, or cursor direction keys, for communicating direction information and command selections to the processor 703 and for controlling cursor movement on the display 711.

According to an embodiment of the invention, the processes described herein are performed by the computer system 700, in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry may be used in place of or in combination with software instructions to implement the embodiment of the invention. Thus, embodiments of the invention are not limited to any specific combination of hardware circuitry and software.

The computer system 700 also includes a communication interface 717 coupled to bus 701. The communication interface 717 provides a two-way data communication coupling to a network link 719 connected to a local network 721. For example, the communication interface 717 may be a digital subscriber line (DSL) card or modem, an integrated services digital network (ISDN) card, a cable modem, a telephone modem, or any other communication interface to provide a data communication connection to a corresponding type of communication line. As another example, communication interface 717 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 717 sends and receives electrical, electromagnetic, or optical signals that carry digital data streams representing various types of information. Further, the communication interface 717 can include peripheral interface devices, such as a Universal Serial Bus (USB) interface, a PCMCIA (Personal Computer Memory Card International Association) interface, etc. Although a single communication interface 717 is depicted in FIG. 7, multiple communication interfaces can also be employed.

The network link 719 typically provides data communication through one or more networks to other data devices. For example, the network link 719 may provide a connection through local network 721 to a host computer 723, which has connectivity to a network 725 (e.g. a wide area network (WAN) or the global packet data communication network now commonly referred to as the “Internet”) or to data equipment operated by a service provider. The local network 721 and the network 725 both use electrical, electromagnetic, or optical signals to convey information and instructions. The signals through the various networks and the signals on the network link 719 and through the communication interface 717, which communicate digital data with the computer system 700, are exemplary forms of carrier waves bearing the information and instructions.

The computer system 700 can send messages and receive data, including program code, through the network(s), the network link 719, and the communication interface 717. In the Internet example, a server (not shown) might transmit requested code belonging to an application program for implementing an embodiment of the invention through the network 725, the local network 721 and the communication interface 717. The processor 703 may execute the transmitted code while being received and/or store the code in the storage device 709, or other non-volatile storage for later execution. In this manner, the computer system 700 may obtain application code in the form of a carrier wave.

The term “computer-readable medium” as used herein refers to any medium that participates in providing instructions to the processor 703 for execution. Such a medium may take many forms, including but not limited to non-volatile media, volatile media, and transmission media. Non-volatile media include, for example, optical or magnetic disks, such as the storage device 709. Volatile media include dynamic memory, such as main memory 705. Transmission media include coaxial cables, copper wire and fiber optics, including the wires that comprise the bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

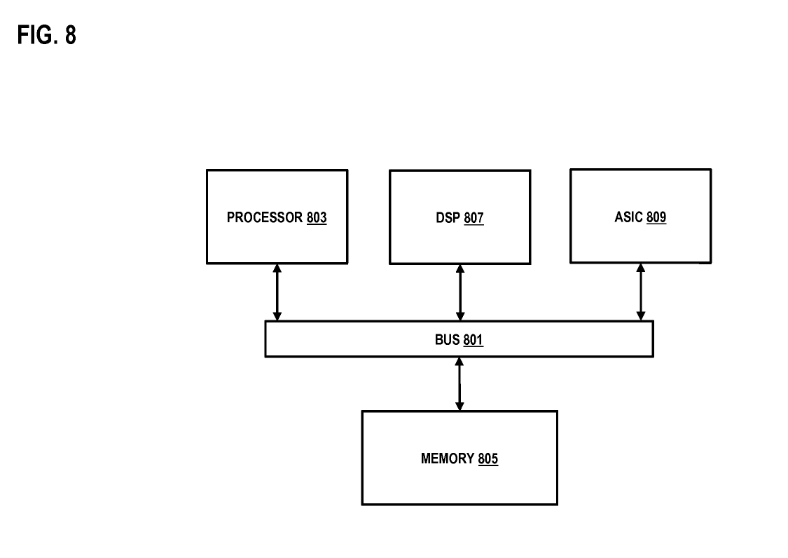

FIG. 8 illustrates a chip set 800 upon which an embodiment of the invention may be implemented. Chip set 800 is programmed to securely transmit payments from mobile devices lacking a physical TSM and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 800, or a portion thereof, constitutes a means for performing one or more steps of FIGS. 4-6.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 805 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
receiving a payment request from a first user directed to a second user, wherein the payment request includes, at least in part, an abstracted identity of the first user;
determining one or more payment accounts associated with the first user based, at least in part, on the abstracted identity;
initiating a payment using the one or more payments accounts to the second user based on the payment request; and
sending an acknowledgement message of the payment to the second user, wherein the acknowledgement message includes anonymized information associated with the payment.

2. A method according to claim 1, further comprising:
processing the payment request to determine an optical media recognition type, a raw media type, a stock keeping unit type, a currency conversion, a currency persistence, or a combination thereof,
wherein the determining of the one or more payment accounts, the initiating of the payment, the sending of the acknowledgement message, or a combination thereof is based on the optical media recognition type, the raw media type, the stock keeping unit type, the currency conversion, the currency persistence, or a combination thereof.

3. A method according to claim 1, further comprising:
generating an anonymized uniform resource identifier associated with the payment request,
wherein the payment request is initiated by an interaction with the anonymized uniform resource identifier.

4. A method according to claim 3, wherein the anonymized uniform resource identifier includes a representative string for identifying a resource that is the subject of the payment request.

5. A method according to claim 1, further comprising:
generating one or more tokens to represent the one or more payments; and
mapping the one or more tokens to the abstracted identity,
wherein the determining of the one or more payment accounts is based on the one or more tokens.

6. A method according to claim 1, wherein the initiating of the payment comprises:
selectively translating the one or more payment accounts to a payment currency.

7. A method according to claim 1, further comprising:
determining the one or more payment accounts based on a payment location associated with the payment request.

8. A method according to claim 1, further comprising:
processing the payment request to determine one or more security risks; and
generating an alert message regarding the one or more security risks,
wherein the one or more security risks include a Man-in-the-Middle attack.

9. An apparatus comprising:
a processor; and
a memory including computer program code for one or more programs,
the memory and the computer program code configured to, with the processor, causing to perform at least the following,
receive a payment request from a first user directed to a second user, wherein the payment request includes, at least in part, an abstracted identity of the first user;
determine one or more payment accounts associated with the first user based, at least in part, on the abstracted identity;
initiate a payment using the one or more payments accounts to the second user based on the payment request; and
send an acknowledgement message of the payment to the second user, wherein the acknowledgement message includes anonymized information associated with the payment.

10. An apparatus according to claim 9, wherein the apparatus is further configured to:
process the payment request to determine an optical media recognition type, a raw media type, a stock keeping unit type, a currency conversion, a currency persistence, or a combination thereof,
wherein the determination of the one or more payment accounts, the initiation of the payment, the sending of the acknowledgement message, or a combination thereof is based on the optical media recognition type, the raw media type, the stock keeping unit type, the currency conversion, the currency persistence, or a combination thereof.

11. An apparatus according to claim 9, wherein the apparatus is further configured to:
generate an anonymized uniform resource identifier associated with the payment request,
wherein the payment request is initiated by an interaction with the anonymized uniform resource identifier.

12. An apparatus according to claim 11, wherein the anonymized uniform resource identifier includes a representative string for identifying a resource that is the subject of the payment request.

13. An apparatus according to claim 9, wherein the apparatus is further configured to:
generate one or more tokens to represent the one or more payments; and
map the one or more tokens to the abstracted identity,
wherein the determination of the one or more payment accounts is based on the one or more tokens.

14. An apparatus according to claim 9, wherein the apparatus is further configured to:
selectively translate the one or more payment accounts to a payment currency.

15. An apparatus according to claim 9, wherein the apparatus is further configured to:
determine the one or more payment accounts based on a payment location associated with the payment request.

16. An apparatus according to claim 9, wherein the apparatus is further configured to:
process the payment request to determine one or more security risks; and
generate an alert message regarding the one or more security risks,
wherein the one or more security risks include a Man-in-the-Middle attack.

17. A method comprising:
initiating a payment request by generating an abstracted identity through an anonymized uniform resource identifier;
generating the payment request, as a result of a confirmed response from the anonymized uniform resource identifier, from a first user directed to a second user, wherein the payment request includes, at least in part, an abstracted identity of the first user; and
receiving an acknowledgement message of the payment to the second user.

18. A method of claim 17, further comprising:
generating the payment request by including an optical media recognition type, a raw media type, a stock keeping unit type, a currency conversion, a currency persistence, or a combination thereof,
wherein a determining of one or more payment accounts, an initiating of the payment, a sending of the acknowledgement message, or a combination thereof is based on the optical media recognition type, the raw media type, the stock keeping unit type, the currency conversion, the currency persistence, or a combination thereof.

19. An apparatus comprising:
a processor; and
a memory including computer program code for one or more programs,
the memory and the computer program code configured to, with the processor, causing to perform at least the following,
initiate a payment request by generating an abstracted identity through an anonymized uniform resource identifier;
generate the payment request, as a result of a confirmed response from the anonymized uniform resource identifier, from a first user directed to a second user, wherein the payment request includes, at least in part, an abstracted identity of the first user; and
receive an acknowledgement message of the payment to the second user.

20. An apparatus according to claim 19, wherein the apparatus is further configured to:
generate the payment request by including an optical media recognition type, a raw media type, a stock keeping unit type, a currency conversion, a currency persistence, or a combination thereof,
wherein a determination of one or more payment accounts, an initiation of the payment, a sending of the acknowledgement message, or a combination thereof is based on the optical media recognition type, the raw media type, the stock keeping unit type, the currency conversion, the currency persistence, or a combination thereof.
